(19) United States
(12) Patent Application Publication
(10) Pub. No.: US 2009/0219818 A1
(43) Pub. Date: Sep. 3, 2009

(54) NODE DEVICE, PACKET SWITCH DEVICE, COMMUNICATION SYSTEM AND METHOD OF COMMUNICATING PACKET DATA

(76) Inventor: Masahiko Tsuchiya, Tokyo (JP)

Correspondence Address: NEC CORPORATION OF AMERICA, 6535 N. STATE HWY 161, IRVING, TX, 75039, US

(21) Appl. No.: 12/395,952

(22) Filed: Mar. 2, 2009

(30) Foreign Application Priority Data
Mar. 3, 2008 (JP) 2008-051621

(51) Int. Cl. H04L 12/56

(52) U.S. Cl. 370/236

(57) ABSTRACT

A node device including a congestion detection unit which detects an occurrence and release of congestion for each class of a second communication quality classification, output to a ring-type network, when packet data for each class classified by a first communication quality classification received from a port; a class association table which stores association between each class of the second communication quality classification and each class of the first communication quality classification; a class conversion unit which converts a class of the second communication quality classification detected by the congestion detecting unit into an associated class of the first communication quality classification; and a notification unit which notifies a class of the first communication quality classification to the port as a target data for stopping read out or starting read out is provided.

This application is based upon and claims the benefit of priority from Japanese patent application No. 2008-051621, filed on Mar. 3, 2008, the disclosure of which is incorporated herein in its entirety by reference.

### BACKGROUND

1. Technical Field

The present invention relates to a node device, a packet switch device, a communication system, and a method of communicating packet data.

2. Background Art

A resilient packet ring (RPR: ring-type packet transmission method) technique which is a ring-type network specified by IEEE 802.17 is disclosed in Japanese Laid-open patent publication NO. 2006-262169. An RPR performs data transmission by a dual-ring configuration in which two unidirectional rings are combined in the opposite directions to each other and provides a packet ring of a band sharing type. Japanese Laid-open patent publication NO. 2006-262169 discloses an inter-ring connection method and device for interconnecting a plurality of RPRS. An RPR standard specified by IEEE 802.17 defines 3 to 5 priority classes and employs a control method for dynamically changing a communication band.

Japanese Laid-open patent publication NO. 2007-194732 discloses a technique in which an optical network unit (ONU) and an optical line terminal (OLT) disposed between a host network and a user house side network monitor a data storage state for each priority class queue and transmit a pause frame with a priority class queue number to a user house side network and a host network. Therefore, pause/restart of traffic transmission is requested in units of priority classes.

Japanese Laid-open patent publication NO. H06-104917 discloses a technique in which a congestion control circuit measures a cell loss ratio for each of queues formed associated with a quality class/an output line and momentarily allocates a spare band to a queue whose loss ratio exceeds an allowable cell loss ratio which is determined in advance associated with a quality class.

Japanese Laid-open patent publication NO. H08-167898 discloses a technique in which packet acceleration or an upper limit value of a packet acceleration ratio is changed to a value of a transmission destination side at a point which interconnects variable speed networks which are different in packet acceleration or an upper limit value of a packet acceleration ratio when a packet is transmitted from one variable speed network to the other variable speed network. If an inter-network connection device detects congestion when a packet is transmitted from one variable speed network to the other variable speed network, the inter-network connection device inserts a congestion prediction signal into a packet which flows in a direction of a variable speed terminal device of a sender side and outputs it to the variable speed terminal device of the sender side. Therefore, the variable speed terminal device of the sender side reduces the packet transmission speed.

Japanese patent application publication NO. 2002-519912 discloses a system for implementing flow control in an information network such as a local area network (LAN) utilizing a Carrier Sense Multiple Access with Collision Detection (CSMA/CD) as specified by the IEEE standard 802.3. In this configuration, a control frame such as a PAUSE frame is provided to an information packet source from a downstream destination to inhibit transmission of information packets such as information frames by the information packet source to the downstream destination for a specific time period.

In an RPR described in Japanese Laid-open patent publication NO. 2006-262169, communication is performed by defining a Quality of Service (“QoS”) class such as band-guaranteed type, a minimum band-guaranteed type and a best effort type which is specified in IEEE 802.17. In order to add data traffic to an RPR, an RPR node device is installed at an ADD point, and packet data output from a packet switch device is output to an RPR through an RPR node. In case where communication between a packet switch device and an RPR node is specified by IEEE 802.3, flow control for data transmission between a packet switch and an RPR node is performed in units of Ethernet (registered trademark) ports. Thus, there is a problem that transmission stop or transmission start is not controlled class by class when traffics of a plurality of QoS classes of an RPR are mixed within a single port.

Therefore, there is a problem that a packet switch device stops data communication of a QoS class which is not congested but communicatable. Also, there is a problem that there is a case where a packet transmitted from a packet switch device is discarded in an RPR node device after it is received by the RPR node device because QoS control in a packet switch device is not succeeded to QoS control in an RPR system.

In Japanese Laid-open patent publication NO. H06-104917, it is necessary to prepare a spare band in advance. Also, in Japanese Laid-open patent publication NO. H08-167898 and Japanese patent application publication NO. 2002-519912, flow control cannot be performed class by class.

Moreover, as described, in case where communication between a packet switch device and an RPR node is specified by IEEE 802.3, a communication quality classification between a packet switch device and an RPR node is different from a communication quality classification of an RPR. In Japanese Laid-open patent publication NO. 2007-194732, however, flow control cannot be performed class by class when there are communication quality classifications which are different in standard.

### SUMMARY

An exemplary object of the invention is to provide a node device, a packet switch device, a communication system, and a method of communicating packet data capable of controlling transmission stop or transmission start class by class when communication quality class classifications are different.

A node device according to an exemplary aspect of the invention includes; a congestion detection unit which detects an occurrence and release of congestion for each class of a second communication quality classification when packet data for each class classified by a first communication quality classification received from a port is output to a ring-type network for each class classified by the second communication quality classification which is different from the first communication quality classification; a class association table which stores association between each class of the second communication quality classification and each class of the first communication quality classification; a class conversion unit which converts a class of the second communication quality classification in which the congestion detecting unit detects an occurrence and release of congestion into an associated class of the first communication quality classification with reference to the class association table; and a notification unit which notifies a class of the first communication quality classification converted by the class conversion unit to the port as a target data for stopping read out or starting read out.

A packet switch device according to an exemplary aspect of the invention includes: a port which outputs packet data for each class classified by a first communication quality classification, wherein the packet switch device is connected to a ring-type network which transmits or receives packet data for each class classified by a second communication quality classification which is different from the first communication quality classification, and the port includes a class-by-class output control unit which designates, as a target data for stopping read out or starting read out, a class of the first communication quality classification obtained by converting a class of the second communication quality classification in which an occurrence or release of congestion is detected into an associated class of the first communication quality classification based on an occurrence and release of packet data congestion for each class of the second communication quality classification in the ring-type network and stops or starts an output of packet data of the class from the port.

A communication system according to an exemplary aspect of the invention includes: a packet switch device which outputs packet data for each class classified by a first communication quality classification; and a node device which receives the packet data output from the packet switch device and outputs the packet data to a ring-type network for each class classified by a second communication quality classification which is different from the first communication quality classification, wherein the node device includes: a congestion detection unit which detects an occurrence and release of congestion for each class of the second communication quality classification; a class association table which stores association between each class of the second communication quality classification and each class of the first communication quality classification; a class conversion unit which converts a class of the second communication quality classification in which the congestion detection unit detects an occurrence or release of congestion into an associated class of the first communication quality classification with reference to the class association table; and a notification unit which notifies a class of the first communication quality classification converted by the class conversion unit to the packet switch device as a target data for stopping read out or starting read out, and the packet switch device includes a class-by-class output control unit which is notified of the class of the target data for stopping read out or starting read out and stops or starts an output of the packet data of the class to the node device.

A method of communicating packet data according to an exemplary aspect of the invention, includes: receiving packet data from a port which outputs the packet data for each class classified by a first communication quality classification and outputting the packet data to a ring-type network for each class classified by a second communication quality classification which is different from the first communication quality classification; detecting an occurrence and release of congestion for each class classified by the second communication classification; converting a class of the second communication quality classification in which an occurrence and release of congestion is detected at the detecting an occurrence and release of congestion into an associated class of the first communication quality classification with reference to a class association table which stores association between each class of the second communication quality classification and each class of the first communication quality classification; and notifying a class of the first communication quality classification converted by the converting into the class to the port as a target data for stopping read out or starting read out.

A certain combination of the components described above and a representation of the present invention transformed between a method, a device, a system a recording medium, and a computer program are also effective as an aspect of the present invention.

### BRIEF DESCRIPTION OF THE DRAWINGS

The above and other objects, advantages and features of the present invention will be more apparent from the following description of certain exemplary embodiments taken in conjunction with the accompanying drawings, in which:

FIG. 1 is a block diagram illustrating a configuration of a communication system which includes an RPR node device and a packet switch device according Lo an exemplary embodiment of the present invention;

FIG. 2 is a view illustrating one example of an internal configuration of a class association table;

FIG. 3 is a view illustrating one example of a configuration of a pause frame transmitted from a class designating pause frame transmission unit;

FIG. 4 is a view illustrating another example of a configuration of a pause frame transmitted from a class designating pause frame transmission unit;

FIG. 5 is a view illustrating one example of a configuration of a node device according to an exemplary embodiment of the present invention;

FIG. 6 is a view illustrating one example of a configuration of a node device according to an exemplary embodiment of the present invention; and

FIG. 7 is a view illustrating one example of a configuration of a communication system which includes a node device and a packet switch device according to an exemplary embodiment of the present invention.

### EXEMPLARY EMBODIMENT

The invention will be now described herein with reference to illustrative exemplary embodiments. Those skilled in the art will recognize that many alternative exemplary embodiments can be accomplished using the advantages of the present invention and that the invention is not limited to the exemplary embodiments illustrated for explanatory purposed.

Hereinafter, exemplary embodiments of the present invention will be described with reference to the accompanying drawings. In the drawings, like reference numerals denote like parts, and a duplicated description will not be repeated.

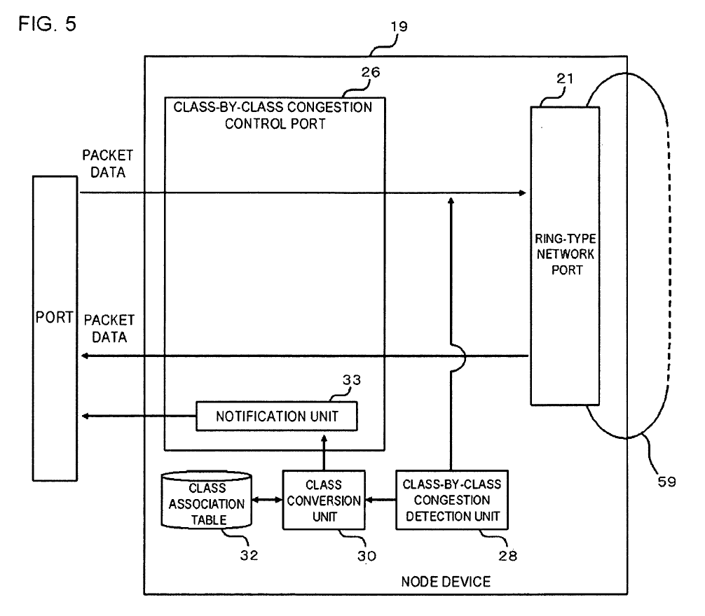

FIG. 5 is a view illustrating one example of a configuration of a node device of the present exemplary embodiment.

A node device 19 includes a ring-type network port 21. The node device 19 is connected to a ring-type network 59 through the ring-type network port 21 to configure the ring-type network 59. The node device 19 includes a class-by-class congestion detection unit (congestion detection unit) 28, a class association table 32, a class conversion unit 30, and a notification unit 33.

The class-by-class congestion detection unit 28 detects an occurrence and release of congestion for each class of a second communication quality classification when packet data for each class classified by a first communication quality classification received from a different port is output to the ring-type network 59 for each class classified by the second communication quality classification which is different from the first communication quality classification. The class association table 32 stores association between each class of the second communication quality classification and each class of the first communication quality classification. The class conversion unit 30 converts a class of the second communication quality classification in which the class-by-class congestion detecting unit 28 detects an occurrence and release of congestion into an associated class of the first communication quality classification with reference to the class association table 32. The notification unit 33 notifies a class of the first communication quality classification converted by the class conversion unit 30 to a different port as a target data for stopping read out or starting read out.

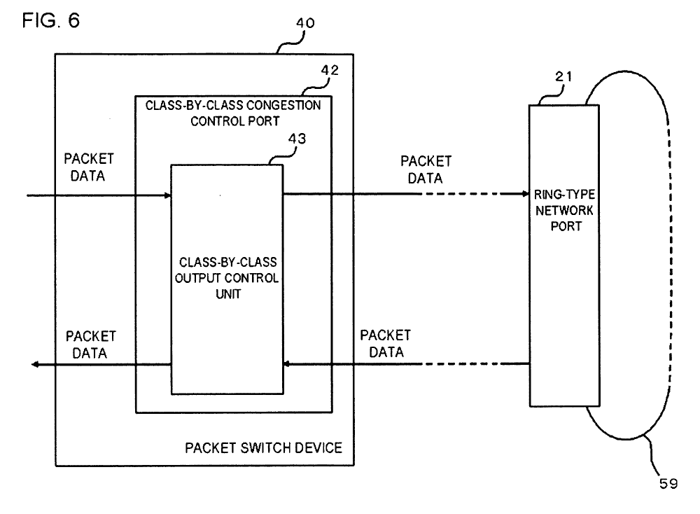

FIG. 6 is a view illustrating one example of a configuration of a node device of the present exemplary embodiment.

A packet switch device 40 includes a class-by-class congestion control port 42 which is a port that outputs packet data for each class classified by a first communication quality classification. The packet switch device 40 is connected to a ring-type network 59 which transmits or receives packet data for each class classified by a second communication quality classification which is different from the first communication quality classification through the ring-type network port 21. The class-by-class congestion control port 42 may be connected to the ring-type network port 21 directly or indirectly through a different port. The class-by-class congestion control port 42 includes a class-by-class output control unit 43. The class-by-class output control unit 43 designates, as a target da a for stopping read out or starting read out, a class of the first communication quality classification obtained by converting a class of the second communication quality classification in which an occurrence or release of congestion is detected into an associated class of the first communication quality classification based on an occurrence and release of packet data congestion for each class of the second communication quality classification in the ring-type network 59 and stops or starts an output of packet data of the class from a port.

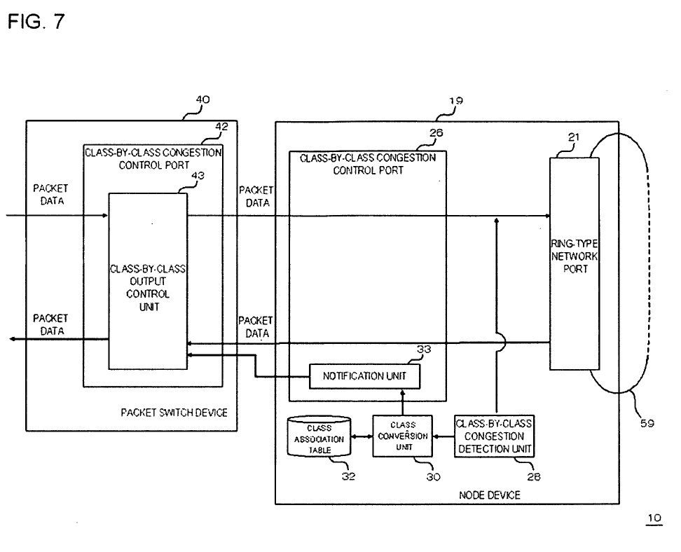

FIG. 7 is a view illustrating one example of a configuration of a communication system which includes a node device and a packet switch device according to the present exemplary embodiment.

A communication system 10 includes a packet switch device 40 which outputs packet data for each class classified by a first communication quality classification, and a node device 19 which receives packet data output from the packet switch device 40 and outputs the packet data to the ring-type network 59 for each class classified by a second communication quality classification which is different from the first communication quality class classification.

The node device 19 has the same configuration as that shown in FIG. 5. A notification unit 33 notifies the packet switch device 40 of a class of the first communication quality classification converted by a class conversion unit 30 as a target data for stopping read out or starting read out. The packet switch device 40 has the same configuration as that shown in FIG. 6.

Next, a detailed exemplary embodiment will be described.

In the below exemplary embodiment, a case where the ring-type network 59 is a resilient packet ring and the node device 19 is an RPR node device will be exemplarily described. In the following exemplary embodiment, the RPR node device which configures the RPR includes a congestion detection function for each QoS class (class classified by the second communication quality classification) of the RPR, a conversion function between a QoS class of the RPR and a QoS class (class classified by the first communication quality classification) at a packet switch, and a notification function of a congestion state to a packet switch device. The packet switch device includes a function of receiving notification of a congestion state for each QoS class at the packet switch from the RPR node device, and a function of stopping or starting transmission of packet data to the RPR node device for each QoS class at the packet switch. Therefore, flow control can be realized for each QoS class. The exemplary embodiment will be described below in more detail with reference to the accompanying drawings.

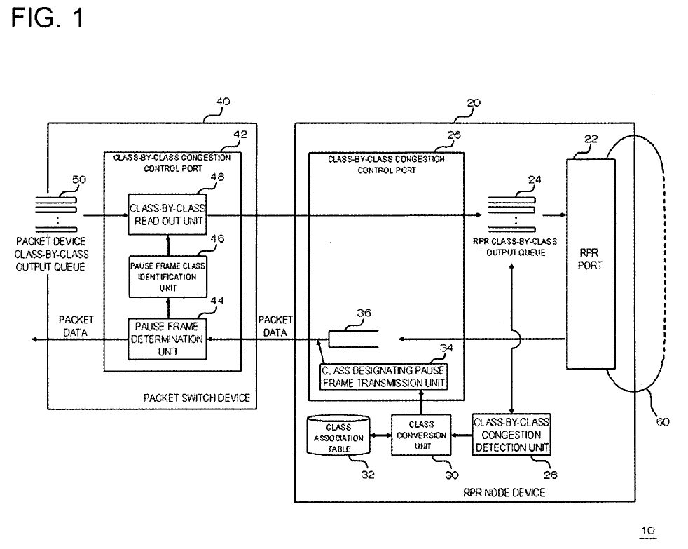

FIG. 1 is a view illustrating a communication system which includes an RPR node device and a packet switch device according to the present exemplary embodiment.

A communication system 10 includes an RPR node device 20 and a packet switch device 40. The RPR node device 20 includes an RPR port 22, an RPR class-by-class output queue 24, a class-by-class congestion control port 26, a class-by-class congestion detection unit 28, a class conversion unit 30, a class association table 32, and an input queue 36. The class-by-class congestion control port 26 includes a class designating pause frame transmission unit 34. The class designating pause frame transmission unit 34 corresponds to the notification units 33 shown in FIGS. 5 arid 7.

The packet switch device 40 includes a class-by-class congestion control port 42 and a packet device class-by-class output queue 50. The class-by-class congestion control port 42 includes a pause frame determination unit 44, a pause frame class identification unit 46 (identification unit) and a class-by-class read out unit 48. The pause frame determination unit 44, the pause frame class identification unit 46 and the class-by-class read out unit 48 correspond to the class-by-class output control unit 43 of FIG. 6. The packet switch device 40 may be realized by, for example, a bridge (Layer 2 switch) or a router (L3 switch).

The respective components of the RPR node device 20 and the packet switch device 40 shown in FIG. 1 represent blocks of functional units other than configurations of hardware units. The respective components of the RPR node device 20 and the packet switch device 40 may be implemented by a combination of hardware and software based on a central processing unit (CPU) of a certain computer, a memory, a program which is loaded into a memory to implement components of the present drawing, a storage unit which stores the program such as a hard disk drive (HDD), and a network connection interface. Those of ordinary skill in the art understand that the implementation method and device may be variously modified.

The class-by-class congestion control port 26 of the RPR node device 20 is connected to an RPR 60 through the RPR port 22 connected through the RPR class-by-class output queue 24. The RPR 60 may include a plurality of RPR ports which are same as the RPR port 22. The class-by-class congestion control port 26 is also interconnected with the class-by-class congestion control port 42 of the packet switch device 40. In the present exemplary embodiment, communication between the class-by-class congestion control port 26 and the class-by-class congestion control port 42 may be specified by IEEE 802.3.

The class-by-class congestion detection unit 28 monitors data traffic for each RPR class transmitted from the RPR class-by-class output queue 24. A congestion detection threshold value for each RPR QoS class is set in each RPR class-by-class output queue 24. Each RPR class-by-class output queue 24 detects a congestion occurrence and a congestion release of communication in the RPR 60 based on a congestion detection threshold value set for each RPR QoS class. The class-by-class congestion detection unit 28 receives a detection result for a congestion occurrence and a congestion release from each RPR class-by-class output queue 24 and detects a congestion state for each RPR QoS class. The class-by-class congestion detection unit 26 notifies the class conversion unit 30 of a change of a congestion state of an associated RPR QoS class if there is a change in congestion state for each RPR QoS class. The class conversion unit 30 refers to a class association table 32 to detect a QoS class of the packet switch device 40 associated with a RPR QoS class notified from the class-by-class congestion detection unit 28. The class conversion unit 30 notifies the class designating pause frame transmission unit 34 of the associated QoS class of the packet switch device 40.

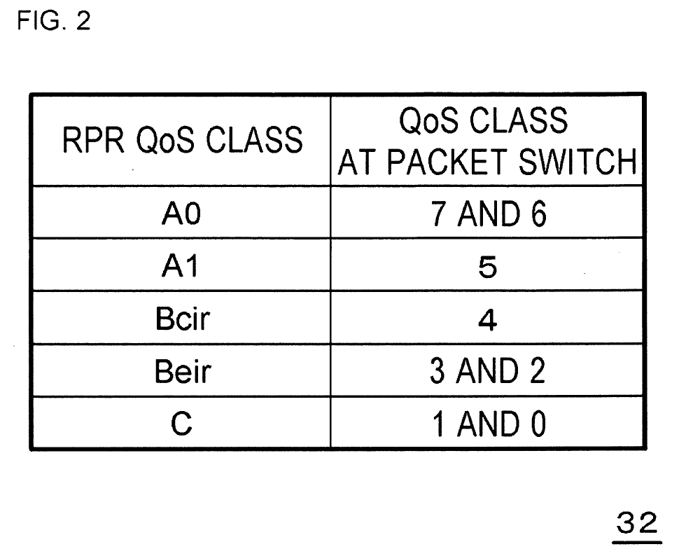

FIG. 2 is a view illustrating one example of an internal configuration of the class association table 32.

The class association table 32 stores a QoS class of the RPR and a QoS class at the packet switch in such a way that the QoS class of the RPR and the QoS class at the packet switch are associated with each other. As the QoS class of the RPR, for example, a classification specified by IEEE 802.17 may be used. As for an example, five classes A0, A1, B-CIR, B-EIR, and C, which are listed in a priority order, may be set. The classes A0 and A1 are full band-guaranteed type traffic, the classes B (B-CIR and B-EIR) are minimum band-guaranteed type traffic, and the class C is best effort type traffic. As for the QoS class at the packet switch, eight classes 7, 6, 5, 4, 3, 2, 1, and 0, which are listed in a priority order, may be set. In the class association table 32, the association between the QoS class of the RPR and the QoS class at the packet switch may be appropriately set but may be set depending on the communication quality, for example, in such a way that QoS classes which are low in communication quality are associated with each other or QoS classes which are high in communication quality are associated with each other. Therefore, the QoS class of the RPR and the QoS class at the packet switch may automatically be associated with each other to a certain extent.

The class designating pause frame transmission unit 34 generates a pause frame which designates an associated QoS class of the packet switch device 40 which is notified from the class conversion unit 30 as a target data for stopping read out or starting read out. The class designating pause frame transmission unit 34 appends the generated pause frame to data packet which is input to the input queue 36 from the RPR 60 and transmits it to the class-by-class congestion control port 42.

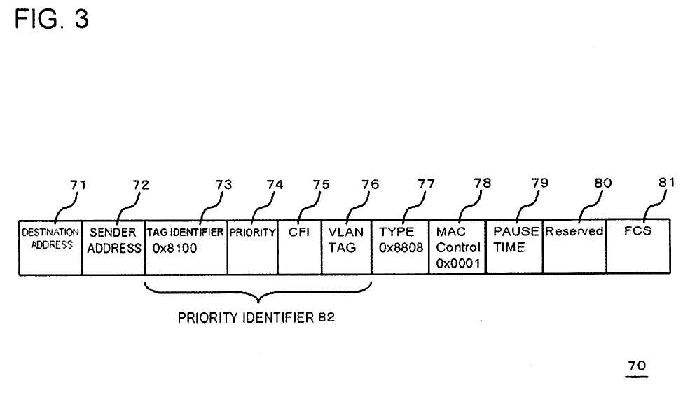

FIG. 3 is a view illustrating one example of a configuration of a pause frame transmitted by the class designating pause frame transmission unit 34.

Here, a virtual local area network (VLAN) TAG identifier is inserted into a pause frame which is specified by IEEE 802.3, and the VLANTAG identifier is used as a priority identifier 82. A pause frame 70 includes fields such as a destination address 71, a sender address 72, a TAG identifier 73, a priority 74, a canonical format indicator (CFI) 75, a VLANTAG 76, a TYPE 77, a MACControl 78, a PAUSETIME 79, a Reserved 80, and a frame check sequence (FCS) 81. Of these, the TAG identifier 73, the priority 74, the CFI 75, and the VLANTAG 76 configure the VLANTAG identifier.

The PAUSETIME 79 may instruct stop of data packet, start of transmission, and a transmission stop time. This function may use control which complies with IEEE 802.3 as it is.

The pause frame determination unit 44 of the packet switch device 40 separates the pause frame from data packet when data packet and the pause frame 70 are transmitted from the RPR node device 20. The pause frame determination unit 44 transmits the separated pause frame to the pause frame class identification unit 46. The pause frame class identification unit 46 identifies a QoS class based on the priority identifier 82 of the pause frame 70 transmitted from the pause frame determination unit 44. The pause frame class identification unit 46 notifies the identified QoS class and an instruction designated in the PAUSETIME 79 to the class-by-class read out unit 48. The class-by-class read out unit 48 stops read out and transmission processing of the packet device class-by-class queue 50 for a QoS class notified from the pause frame class identification unit 46. Therefore, a transmission frame of an associated QoS class to the class-by-class congestion control port 26 is stopped.

Next, an operation of QoS class-by-class flow control will be described with reference to FIGS. 1 to 3.

The class-by-class congestion detection unit 28 notifies an occurrence of congestion and an RPR QoS class in which congestion occurs to the class conversion unit 30 when the class-by-class congestion detection unit 28 detects a congestion occurrence of any RPR QoS class. The class conversion unit 30 detects an associated QoS class of the packet switch device 40 with reference to the class association table 32. For example, when the class-by-class congestion detection unit 28 detects a congestion occurrence of an RPR QoS class “A1”, the class conversion unit 30 reads out the QoS class “5” at the packet switch associated with the RPRQoS class “A1” with reference to the class association table 32. The class conversion unit 30 notifies the QoS class “5” at the packet switch and a congestion occurrence to the class designating pause frame transmission unit 34. The class designating pause frame transmission unit 34 transmits the pause frame 70 shown in FIG. 3 to the class-by-class congestion control port 42 from the class-by-class congestion control port 26. At this time, information which indicates the QoS class “5” at the packet switch is included in the priority 74 field. A stop instruction of data packet is included in the PAUSETIME 79. Also, a meaningless value (for example, “0”), which is not limited to a specific value, may be included in, for example, the VLANTAG 76 of the priority identifier 82.

As another example, a case where the class-by-class congestion detection unit 28 detects congestion of an RPR QoS class “A0” will be described. Referring to FIG. 2, an RPR QoS class “A0” is associated with QoS classes “7” and “6” at the packet switch. In this case, the class designating pause frame transmission unit 34 transmits to the class-by-class congestion control port 42 two pause frames: a pause frame in which information indicating the QoS class “7” at the packet switch is included in the priority 74 field; and a pause frame in which information indicating the QoS class “6” at the packet switch is included in the priority 74 field.

In the packet switch device 40, the pause frame determination unit 44 receives data packet and the pause frame from the class designating pause frame transmission unit 34. The pause frame determination unit 44 separates the received pause frame from data packet. Subsequently, the pause frame determination unit 44 transmits the separated pause frame to the pause fame class identification unit 46. The pause frame class identification unit 46 reads out class information from the priority 74 field of the received pause frame and pause control information which represents transmission stop, transmission start or temporary transmission stop from the PAUSETIME 79 field, respectively, and notifies them to the class-by-class read out unit 48. The class-by-class read out unit 48 performs control such as stop, start and temporary stop of data of a designated class from the packet device class-by-class output queue 50. Therefore, class-by-class pause control is achieved.

Next, exemplary advantages of the communication system 10 according to the present exemplary embodiment will be described.

According to the communication system 10 of the present exemplary embodiment, even when packet data output to the RPR 60 and packet data output from the packet switch device 40 are different in communication quality classification, transmission of packet data can be controlled class by class, depending on a congestion state of each class.

According to the communication system 10 of the present exemplary embodiment, flow control according to a congestion state of an RPR QoS class can be performed with respect to data traffic on a communication path between the RPR node device 20 and the packet switch device 40. Therefore, even when congestion occurs in traffic of a certain RPR QoS class, a phenomenon that traffic of any other QoS class is stopped between the RPR node device 20 and the packet switch device 40 can be prevented since RPR QoS control cooperated with the packet switch device can be performed. Transmission of packet data can be performed without any packet loss from the packet switch device 40 with respect to the traffic flow rate of each QoS class which dynamically changes in the RPR.

Also, like the RPR, in order to guarantee the classes A0 and A1 which are full band-guaranteed type traffic, the packet switch device 40 also needs to guarantee full band-guaranteed type traffic. Therefore, it is necessary to mount a band adjusting shaper circuit in both the packet switch device 40 and the RPR node device 20 and to limit a band at output points of both nodes. However, according to the communication system 10 of the present exemplary embodiment, transmission of packet data can be performed without any packet loss from the packet switch device 40. Therefore, full band-guaranteed type traffic can be guaranteed by installing a shaper circuit only in the RPR node device 20 without mounting a shaper circuit at the packet switch device 40.

In order to achieve a fair transmission control function or a priority transmission control function for each micro flow when the packet switch device 40 accesses the RPR through the RPR node device 20, it is typically necessary to add a physical (virtual) queue to a class-by-class output queue of each of the packet switch device 40 and the RPR node device 20 to control transmission. However, transmission of packet data can be performed without any packet loss from the packet switch device 40. Therefore, the RPR node device 20 can effectively utilize a function of the packet switch device 40 side, and thus a fair transmission control function or a priority transmission control function for each micro flow can be achieved by installing a physical queue only in the packet switch device 40 without mounting a physical queue in the RPR node device 20.

An exemplary advantage according to the invention is that packet data transmission can be controlled class by class depending on a congestion state of each class even when communication quality classifications are different.

Hereinbefore, the exemplary embodiment of the present invention has been described with reference to the accompanying drawings, but it is merely an example of the present invention, and the present invention can employ various configurations other than that described above.

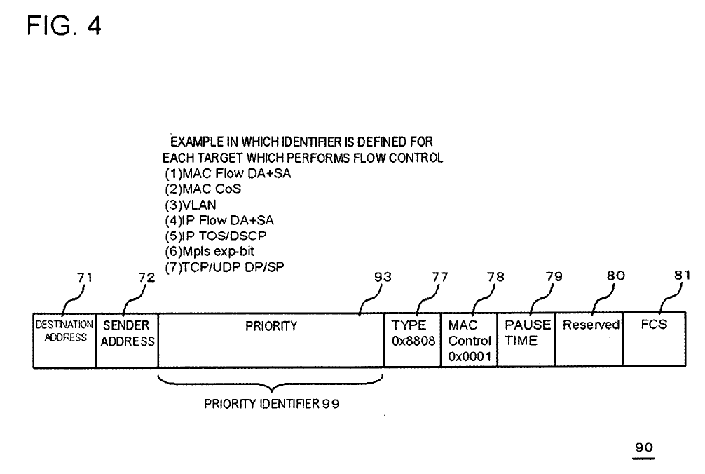

In the exemplary embodiment described above, the VLANTAG of IEEE 802.1Q is used to notify a priority, but a priority identifier for notifying a priority between the RPR node device 20 and the packet switch device 40 may be discretely defined. Since conversion between a QoS class of the RPR and a QoS class of the packet switch device is performed, traffic control of a certain flow like an IP flow and an IP priority or a MAC flow and a MAC priority can be achieved. FIG. 4 is a view illustrating another example of a pause frame shown in FIG. 3. Here, a pause frame 90 can define traffic of various layers as a priority identifier 99 such as an MAC layer, an IP layer, and a transport layer (fourth layer) of an OSI7 layer used in data communication as a flow control target. As the priority identifier 99, (1) MAC Flow DA+SA, (2) MAC CoS, (3) VLAN, (4) IP Flow DA+SA, (5) IP TOS/DSCP, (6) Mpls exp-bit, or (7) TCP/UDP DP/SP may be used.

Also, in the exemplary embodiment described above, the packet switch device 40 and the node device 20 are described as independent devices, but the RPR node device 20 may be configured to be mounted inside the packet switch device 40.

Furthermore, in the exemplary embodiment described above, the node device 19 (RPR node device 20) has a configuration which includes the class conversion unit 30 and the class association table 32, but the packet switch device 40 may have a configuration which includes the class conversion unit 30 and the class association table 32 instead. In this case, at the node device 19 side, the class-by-class congestion detection unit 28 detects a congestion occurrence and a congestion release of a class of the second communication classification, and the notification unit 33 notifies them to the class conversion unit 30 of the packet switch device 40. The class conversion unit 30 notifies an associated class of the first communication quality classification to the class-by-class output control unit 43 with reference to the class association table 32. Accordingly, processing which is same as described above can be performed.

Association of the class association table 32 may be externally changed if necessary. By externally performing association of the class association table 32 as described above, an association method of different communication quality classes becomes flexible, and thus congestion control can be more appropriately performed.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A node device comprising:
a congestion detection unit which detects an occurrence and release of congestion for each class of a second communication quality classification when packet data for each class classified by a first communication quality classification received from a port is output to a ring-type network for each class classified by said second communication quality classification which is different from said first communication quality classification;
a class association table which stores association between each class of said second communication quality classification and each class of said first communication quality classification;
a class conversion unit which converts a class of said second communication quality classification in which said congestion detecting unit detects an occurrence and release of congestion into an associated class of said first communication quality classification with reference to said class association table; and
a notification unit which notifies a class of said first communication quality classification converted by said class conversion unit to said port as a target data for stopping read out or starting read out.

2. The node device as claimed in claim 1, wherein said class association table stores a class of said first communication quality classification and a class of said second communication quality classification depending on a communication quality in such a way that classes which are low in communication quality are associated with each other and classes which are high in communication quality are associated with each o her.

3. The node device as claimed in claim 1, wherein said second communication quality classification comprises a Quality of Service (QoS) class of a band-guaranteed type.

4. The node device as claimed in claim 1, wherein said ring-type network is a resilient packet ring (RPR).

5. The node device of claim 1, wherein communication between said port and said node device is specified by IEEE 802.3, and said second communication quality classification is specified by IEEE 802.17.

6. The node device of claim 1, wherein said notification unit transmits a pause frame which designates a class of said first communication quality classification as a target data for stopping read out or starting read out to said port.

7. A packet switch device comprising:
a port which outputs packet data for each class classified by a first communication quality classification,
wherein said packet switch device is connected to a ring-type network which transmits or receives packet data for each class classified by a second communication quality classification which is different from said first communication quality classification, and
said port includes a class-by-class output control unit which designates, as a target data for stopping read out or starting read out, a class of said first communication quality classification obtained by converting a class of said second communication quality classification in which an occurrence or release of congestion is detected into an associated class of said first communication quality classification based on an occurrence and release of packet data congestion for each class of said second communication quality classification in said ring-type network and stops or starts an output of packet data of said class from said port.

8. The packet switch device as claimed in claim 7, wherein said packet switch device is connected to said ring-type network through a node device which outputs packet data to said ring-type network for each class classified by said first communication quality classification, and
said port is notified of a class of a target data for stopping read out or starting read out from said node device and stops or starts an output of said packet data of said class from said port.

9. A communication system comprising:
a packet switch device which outputs packet data for each class classified by a first communication quality classification; and
a node device which receives said packet data output from said packet switch device and outputs said packet data to a ring-type network for each class classified by a second communication quality classification which is different from said first communication quality classification,
wherein said node device includes:
a congestion detection unit which detects an occurrence and release of congestion for each class of said second communication qualify classification;
a class association table which stores association between each class of said second communication quality classification and each class of said first communication quality classification;
a class conversion unit which converts a class of said second communication quality classification in which said congestion detection unit detects an occurrence or release of congestion into an associated class of said first communication quality classification with reference to said class association table; and
a notification unit which notifies a class of said first communication quality classification converted by said class conversion unit to said packet switch device as a target data for stopping read out or starting read out, and
said packet switch device includes a class-by-class output control unit which is notified of said class of said target data for stopping read out or starting read out and stops or starts an output of said packet data of said class to said node device.

10. The communication system as claimed in claim 9, wherein said class association table stores a class of said first communication quality classification and a class of said second communication quality classification depending on a communication quality in such a way that classes which are low in communication quality are associated with each other and classes which are high in communication quality are associated with each other.

11. The communication system as claimed in claim 9, wherein said second communication quality classification comprises a Quality of Service (QoS) class of a band-guaranteed type.

12. The communication system of claim 9, wherein said ring-type network is a resilient packet ring (RPR).

13. The communication system of claim 9, wherein communication between said packet switch device and said node device is specified by IEEE 802.3, and said second communication quality classification is specified by IEEE 802.17.

14. The communication system of claim 9, wherein said notification unit of said node device transmits a pause frame which designates a class of said first communication quality classification as a target data for stopping read out or starting read out to said packet switch device, and
said packet switch device outputs packet data accumulated in an output queue to said node device for each class classified by said first communication quality classification, and
said packet switch device further includes an identification unit which identifies a class of said first communication quality classification designated as a target data for stopping read out or starting read out based on said pause frame transmitted from said node device and a class-by-class read out unit which stops or starts read out of said packet data of said class identified by said identification unit from said output queue.

15. A method of communicating packet data comprising:
receiving packet data from a port which outputs said packet data for each class classified by a first communication quality classification and outputting said packet data to a ring-type network for each class classified by a second communication quality classification which is different from said first communication quality classification;
detecting an occurrence and release of congestion for each class classified by said second communication classification;
converting a class of said second communication quality classification in which an occurrence and release of congestion is detected at said detecting an occurrence and release of congestion into an associated class of said first communication quality classification with reference to a class association table which stores association between each class of said second communication quality classification and each class of said first communication quality classification; and
notifying a class of said first communication quality classification converted by said converting into said class to said port as a target data for stopping read out or starting read out.

16. The method of communicating packet data as claimed in claim 15, wherein said notifying to said port includes transmitting a pause frame which designates a class of said first communication quality classification as a target data for stopping read out or starting read out to said port.

17. The method of communicating packet data as claimed in claim 15, further comprising, stopping or starting an output of said packet data of said class from said port based on notification at said notifying to said port.

18. The method of communicating packet data of claim 15, wherein said second communication quality classification comprises a Quality of Service (QoS) class of a band-guaranteed type.

19. The method of communicating packet data of claim 15, wherein said ring-type network is a resilient packet ring (RPR).

20. The method of communicating packet data of claim 15, wherein an output of said packet data from said port is specified by IEEE 802.3, and said second communication quality classification is specified by IEEE 802.17.

21. The method of communicating packet data as claimed in claim 16, further comprising:
outputting packet data accumulated in an output queue for each class classified by said first communication quality classification from said port;
identifying a class of said first communication quality classification designated as a target data for stopping read out or starting read out based on said pause frame notified at said notifying to said port; and
stopping or starting read out of said packet data of said class identified at said identifying said class from said output queue.
